(19) United States
(12) Patent Application Publication
(10) Pub. No.: US 2006/0001914 A1
(43) Pub. Date: Jan. 5, 2006

(54) Color scanner display

(76) Inventors: Ralph M. Mesmer, Banks, OR (US); Ken K. Lee, Portland, OR (US); Lawrence A. Booth JR., Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,416

(22) Filed: Jun. 30, 2004

(51) Int. Cl. H04N 1/00

(52) U.S. Cl. 358/401

(57) ABSTRACT

Methods and apparatus to scan an object with a color display are disclosed. In one aspect, an apparatus may include a driver to control sub-pixels of a color display, and logic of the driver to cause a first sub-pixel of the color display to emit light and a second sub-pixel of the color display to detect light.

### BACKGROUND

1. Field

An embodiment of the invention relates to a display that is capable of scanning an object.

2. Background Information

Liquid crystal displays (LCDs) are commonly used in computers, cellular phones, and other electronic devices to display information. In an article entitled “Prototype LCD with Built-In Scanner Unveiled”, by Martyn Williams, published on the Internet in PCAdvisor.co.uk, on Apr. 9, 2003, Toshiba Corporation announced a prototype LCD with a built in scanner. As reported in the article, the prototype included a polysilicon thin film transistor (TFT) LCD with added image sensors among the display pixels. As further reported, although the screen of the prototype can display colors, the scanner can only manage monochrome images, not color images.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 shows a color scanner display apparatus scanning an object, according to one embodiment of the invention.

FIG. 2 shows a color scanner liquid crystal display (LCD) apparatus, according to one embodiment of the invention.

FIG. 3 shows a timing diagram for signals in an exemplary implementation of a color scanner display apparatus, according to one embodiment of the invention.

FIG. 4 shows a method of generating an image of an object being scanned, according to one embodiment of the invention.

FIG. 5 shows an exemplary electronic device, according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

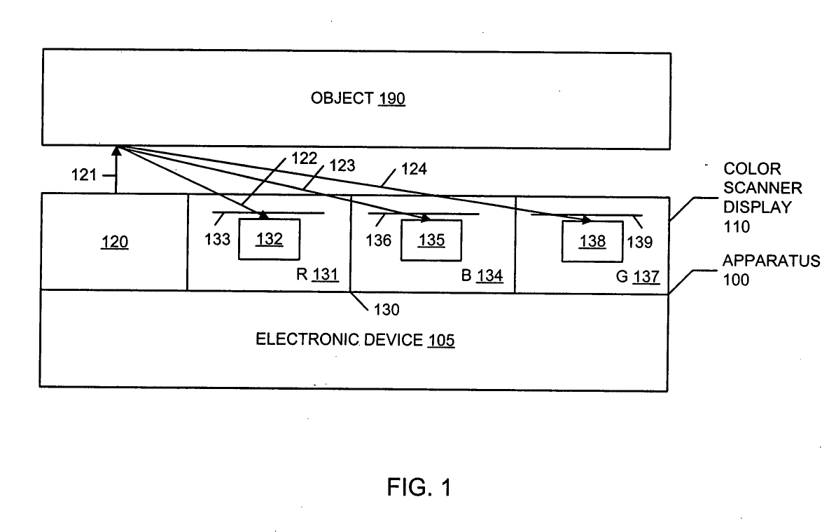

FIG. 1 shows a color scanner display apparatus 100 scanning an object 190, according to one embodiment of the invention. The apparatus includes an electronic device 105 and a color scanner display 110. The electronic device may include a desktop computer, laptop computer, television, cellular phone, video-capable mobile phone, personal digital assistant (PDA), or e-book, to name just a few examples. The display may include an active matrix liquid crystal display (LCD), or active matrix bottom emitter organic light emitting diode (OLED) display, for example. An OLED display is sometimes referred to as an organic light emitting display.

The display may include an array of pixels. The pixels generally represents small discrete elements on a display screen, such as may be found in LCDs, for example. In order to avoid obscuring the description, a first pixel 120 and a second pixel 130 are shown. In various embodiments of the invention, the first and the second pixels may represent adjacent pixels, such as pixels next to one another in a row or column, neighboring, or otherwise proximate pixels (meaning herein within five pixels of each other). It will be evident that the array may include thousands, or millions, of such pixels.

Each pixel of the array may include three independently controlled sub-pixels. The illustrated second pixel includes, from left-to-right, a red sub-pixel 131, a blue sub-pixel 134, and a green sub-pixel 137. The illustrated order within the pixel is not required. The first pixel 120, which is shown in simplified format, may be similar to the second pixel 130, and may include analogous red, blue, and green sub-pixels.

Each sub-pixel may be capable of generating, transmitting, or otherwise emitting a different color and intensity of additive primary light such as red light, blue light, and green light. For example, an OLED may generate light, whereas a liquid crystal may transmit light. The red-sub-pixel may emit red light, the blue sub-pixel may emit blue light, and the green sub-pixel may emit green light. The colors red, green, and blue are additive primary colors. When these three colors are combined in equal intensities, white light may be produced. When two or more of these colors are combined in varying intensities, a large palette of colors may be produced.

The apparatus may use these pixels, and sub-pixels, in conventional manner to display information, such as text, images, graphics, and the like. The apparatus may also use these pixels, and sub-pixels, to scan objects.

In an exemplary method, a user may place the object against the display, press a scan button, for example, and wait a few seconds while the apparatus scans the object. Once the object is scanned, an image or other representation of the object may be presented, for example in multi-color format, on the display, where the user may view the object.

In the illustration, the object is placed in position in front of the display. The object may include a page of text, business card, bar code, map, print, photograph, fingerprint, fabric, wallpaper, or leaf, to name just a few examples. In one aspect, the object may include colors, such as, for example, red, green, blue, cyan, magenta, yellow, or combinations of such colors, although this is not required. To facilitate illustration, a distance is shown between the object and the display, although the object may also optionally be placed on or directly against the display.

The apparatus is shown scanning the object. In scanning the object, the display may emit light to illuminate the object in front of the display. In the illustrated embodiment of the invention, the display illuminates the object by emitting white light 121 with the first pixel. In one aspect, each of the red, blue, and green sub-pixels of the first pixel may emit substantially equal intensities of light. In another embodiment of the invention, one or more white sub-pixels of the display may be used to emit the white light. In one aspect, both the red, blue, and green pixels operating at equal intensities, and the white sub-pixels, may be used to emit the white light.

The object may absorb some of the emitted white light. In general, black and other darkly colored objects tend to absorb light more than white and other lightly colored objects. For example, in the case of the object including a print made of cyan, magenta, and yellow, cyan portions of the print may tend to absorb or subtract red light of the emitted light, since red is the complementary color of cyan, while magenta and yellow portions of the print may tend to reflect the red light. Likewise, magenta may tend to absorb or subtract green light, and yellow may tend to absorb or subtract blue light. Some of the light may also be lost for various reasons.

At least some of the emitted light that is used to illuminate the object may be reflected back to the display by the object. As shown in the illustrated embodiment of the invention, a first portion 122 may be reflected back to the red sub-pixel, a second portion 123 may be reflected back to the blue sub-pixel, and a third portion 124 may be reflected back to the green sub-pixel.

The sub-pixels may each include color filters to color light. As shown in the illustrated embodiment of the invention, the red sub-pixel may include a red color filter 133, the blue sub-pixel may include a blue color filter 136, and the green sub-pixel may include a green color filter 139. The color filters may potentially absorb light that is emitted through them, or that is reflected back through them.

The sub-pixels of the second pixel may each include a photodetector that may be used to detect light. In particular, the red sub-pixel includes a first photodetector 132, the blue sub-pixel includes a second photodetector 135, and the green sub-pixel includes a third photodetector 138.

The photodetectors generally represent minute devices or transducers to detect radiant energy through photoelectric action. The photodetectors may accept an optical signal, such as light reflected by the object through a filter, and produce a corresponding electrical signal. In one aspect, the magnitude of the electrical signal may be correlated with, or at least related to, the intensity of the optical signal. The magnitude may also depend on other factors, such as the capacity of the sub-pixel, and the transconductance of the gate, for example.

In one embodiment of the invention, a dedicated photodetector may be included in a sub-pixel and used to detect light. Suitable photodetectors include, but are not limited to, photodiodes (PDs), avalanche photodiodes (APDs), charge coupled devices (CCDs), other radiant energy sensitive devices or microelectronic devices, and combinations thereof. Two or more photodetectors may also optionally be used in each sub-pixel. The photodetector may be located at various locations. In one aspect, the photodetector may be behind a liquid crystal, such as, for example, on a thin film transistor substrate. Alternatively, in another aspect, the photodetector may be between the object and the liquid crystal, such as, for example, in the area of a blackmask, or on a row or column line. In the case of a transflective display, the photodetector may be located on the reflective part of the sub-pixel.

In another embodiment of the invention, a thin film transistor (TFT) may be used as a photodetector. In one aspect, a TFT that is native to the display and used in another role to display information, for example as a switch used to control or configure a liquid crystal or OLED, may be used as a photodetector. That is, the same TFT may be used for both scanning and display. The gate of the TFT may be photosensitive. In one aspect, the TFT may optionally be re-biased to make it further sensitive to light. For example, doping or other characteristics of the TFTs may be adapted, or re-biasing current or voltage may be provided to the TFTs, so they better serve a dual role as both photodetector and switch. The gate may also optionally be enlarged to provide greater area for absorbing light. Amorphous silicon may also optionally be employed, since it may tend to be more photosensitive than low temperature polysilicon. In one aspect, the native TFT may be behind a liquid crystal. Alternatively, in another aspect, the native TFT may be between the object and the liquid crystal, such as, for example on a blackmask, or on a row or column line.

In yet another embodiment of the invention, a native diode of the display may be used as a photodetector. For example, a thin film diode (TFD) as conventionally used in some LCDs may be used as a photodetector. The diode may be used both in display and scanning.

The photodetectors of the red, blue, and green sub-pixels may each receive and detect the first 122, second 123, and third 124 portions of the reflected light, respectively. The TFTs or other photodetectors may each provide currents, voltages, or other electrical signals, based on the detected light, to a scanning circuit, software, or other portion of the apparatus (for example a column driver). The magnitude of the electrical signals may each be related to the intensity of the light detected by the corresponding sub-pixel.

As shown in the illustrated embodiment, the portions of the light that are detected by the photodetectors each pass through one of the colored filters. The red color filter is primarily transparent to red light, and is less transparent to other colors of light. The blue and the green filters are likewise more transparent to blue and green colored light, respectively. Accordingly, the relative amounts of light reflected back to the photodetectors of the red, blue, and green sub-pixels, and collected through the corresponding color filters, may provide information about the red, blue, and green color components of the local area of the object being scanned. As will be discussed further below, the information about the red, blue, and green colors of the object may be combined to generate a multi-colored image or other representation of the object being scanned.

It is not required that white light be used. In another embodiment of the invention, red, green, and blue sub-pixels may each emit at different intensities, so that a wide variety of different colors of light may be used to illuminate the object, such as cyan, magenta, yellow, sky blue, tangerine, to name just a very few examples. Colors ranging from near white, to near red, blue, or green may be used. For generation of accurate color images of objects, better results are generally achieved by including sufficient amounts of each of red, blue, and green light in the emitted light, although the invention is not so limited.

The scanning method disclosed above may be repeated by other pixels of the display. In one aspect, the scan may proceed row-by-row with alternating pixels in a row being used either to emit light or detect reflected light. In one aspect, the pixels used to emit and detect may be somewhat evenly distributed over the array of pixels of the display in order to collect reflectance information over the entire domain of the object. Many, a majority, or all of the pixels of a display may be used to scan an object in order to provide higher quality scans. Generally, the more pixels and sub-pixels utilized for the scan, the better the resolution or quality of the scan. However, it is not required to use all the pixels, nor is it required to use equal numbers of pixels to emit and detect. Many variations are contemplated.

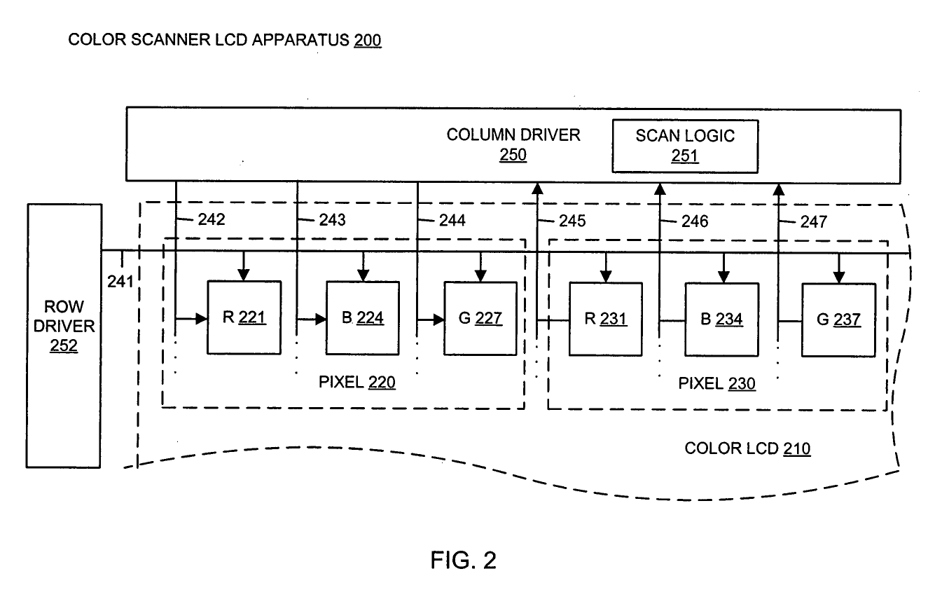

To further illustrate certain concepts, consider an exemplary color scanner LCD. FIG. 2 shows a color scanner LCD apparatus 200, according to one embodiment of the invention. The apparatus includes a color LCD 210, a first pixel 220 of the display, a second pixel 230 of the display, a column driver 250 coupled with the LCD, scan logic 251 of the column driver, and a row driver 252 coupled with the LCD. A portion of the display is shown. In an actual implementation, the display may include thousands or millions of such pixels.

The illustrated pixels each include red, blue, and green sub-pixels. In particular, the first pixel 220 includes a red sub-pixel 221, a blue sub-pixel 224, and a green sub-pixel 227. The second pixel includes a red sub-pixel 231, a blue sub-pixel 234, and a green sub-pixel 237.

Each of the sub-pixels is coupled with the column driver and the row driver. The row driver is electrically coupled with each of the illustrated sub-pixels of the row through a row select line 241. The column driver is individually and bi-directionally electrically coupled with the red, blue, and green sub-pixels of each of the first and the second pixels. In particular, the column driver is coupled with the red, blue, and green sub-pixels of the first pixel by a red sub-pixel column select line 242, a blue sub-pixel column select line 243, and a green sub-pixel column select line 244, respectively. Likewise, the column driver is coupled with the red, blue, and green sub-pixels of the second pixel by a second red sub-pixel column select line 245, a second blue sub-pixel column select line 246, and a second green sub-pixel column select line 247, respectively.

The column driver and the row driver may be used to control the pixels and sub-pixels of the display. The drivers are occasionally referred to as controllers. The column driver and the row driver may include one or more electronic circuits or other logic that may provide control signals, such as, for example, voltages, to the individual sub-pixels through the above-described lines. An exemplary column driver may include, for example, an 8-bit driver circuit that may provide 256 unique values per sub-pixel.

To address a particular sub-pixel, the row driver may assert a row selection signal on a corresponding row select line. Other rows of the display, which may have their own row select lines, may be un-selected or turned off. The row driver may then cycle through the other rows of the display. The column driver may assert one or more selection signals down one or more colored sub-pixel column select lines. Sub-pixels at the intersection of the selected rows and columns may be addressed.

According to one or more embodiments of the invention, the apparatus and the drivers may be used both to display data and to scan objects, such as color objects, for example. The illustrated column driver includes the scan logic. The logic may include hardware, such as, for example, circuitry, although firmware, software, or a combination of one or more of hardware, firmware, and software may also optionally be used. In one embodiment of the invention, the scan logic may include circuitry within the column driver to cause one or more sub-pixels of the color display to emit light, and to cause one or more different sub-pixels of the color display to detect light.

In the illustrated embodiment of the invention, scan logic may cause the red, blue, and green sub-pixels of the first pixel 220 to emit light, and cause the red, blue, and green sub-pixels of the second pixel 230 to detect light. To achieve this, the column driver may assert selection signals down the red, blue, and green sub-pixel column selection lines 242-244 of the first pixel. The row driver may assert a selection signal down the row selection line 241. This may cause the sub-pixels of the first pixel to emit light. In one aspect, the column driver may cause each of the sub-pixels to emit light with equal intensities in order to emit a white light. The column driver may defer from asserting selection signals down the red, blue, and green sub-pixel column selection lines 245-247 of the second pixel 230. Accordingly, these sub-pixels are not addressed or selected to emit light, and may in one aspect, be used to detect light.

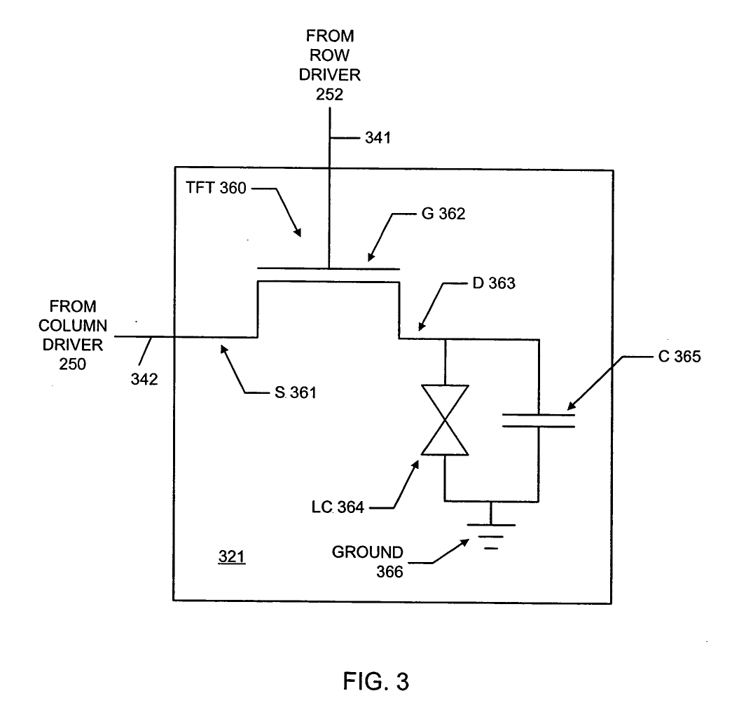

To further illustrate certain concepts, according to an embodiment of the invention, it may be helpful to consider exemplary circuitry of a sub-pixel. FIG. 3 shows an exemplary sub-pixel 321, according to one embodiment of the invention. The illustrated sub-pixel includes a thin film transistor (TFT) 360, a liquid crystal (LC) 364, a capacitor (C) 365, and a connection to ground (GR) 366. Alternatively, the capacitor may optionally be replaced by another charge storage device. The TFT includes a source (S) 361, a gate (G) 362, and a drain (D) 363. The source is electrically coupled with the column driver 250 through a sub-pixel column selection line 342. The gate is electrically coupled with the row driver 252 through a row selection line 341. The drain is connected with the liquid crystal and the capacitor, which are connected in parallel. The liquid crystal and the capacitor are also connected to the ground at the opposite end.

The TFT of the sub-pixel may be used as a switch to the capacitor to control the orientation of the liquid crystal. The anode and cathode of the sub-pixel may act as the capacitor. Voltage from the row driver may control the gate of the TFT to allow or disallow current flow between the source and the drain. Voltage from the column driver may be communicated from the source to the drain when the gate is appropriately configured by the row driver. The drain may be connected to an active area of the sub-pixel. The capacitor may receive the charge and a field may be generated between the indium-tin oxide (ITO) electrode and the drain area electrode. The charged capacitor may alter the orientation or alignment of the liquid crystal, which may align predictably when stimulated with electricity, and allow the emission of light by the sub-pixel. The light may be colored by a filter. The capacitor may hold the charge until the next refresh cycle or sequence of the row driver. Other embodiments of the invention are not limited to the illustrated circuitry. Numerous alternate examples of suitable sub-pixel circuitry abound in the literature, such as, for example, circuitries including multiple capacitors, multiple transistors, and different connections of the components.

In one embodiment of the invention, a native TFT of a sub-pixel, such as the TFT 360, may be used to detect light during scanning. In another role, the native TFT may be used to switch a liquid crystal, or to cause a sub-pixel to emit light, for example. That is, the same TFT may be used both to switch a liquid crystal and detect light. The gate of the TFT may detect light and produce an electrical signal that may be indicative of, or at least related to, an intensity or amount of light that is detected by the TFT. In one aspect, the electrical signal may be provided to the column driver through the source of the transistor and the colored sub-pixel column select line 342. The sub-pixels may be bi-directionally coupled with the column driver to both receive signals from the column driver and provide signals, such as signals indicating detected light, to the column driver. In one embodiment of the invention, the TFTs may be formed in an amorphous silicon substrate. TFTs formed of amorphous silicon tend to be larger than those formed of low temperature polysilicon. A larger TFT generally implies a larger area to detect light.

Alternatively, in another embodiment of the invention, instead of or in addition to using a native TFT, one or more dedicated photodetectors, such as diodes, PDs, APDs, CCDs, or transistors, for example, may be included in a display and used to detect light. The scan logic may include logic to cause the dedicated photodetector to detect light. The display may include one or more additional lines from the column driver to each of the photodetectors to activate the photodetectors and receive information or signals from the photodetectors.

The scan logic may include logic to receive signals from the TFTs or other photodetectors, and process the signals, for example by extracting a voltage, current, or other information such as a digital value representative of the amount of detected light, from the signals. The column driver may include a link or electrical connection to a processor, such as through an LCD controller or a component with a connection to a processor, for example. The column driver may provide the information to a processor, for example, which may process the information to generate an image or other representation of the object being scanned, which may be displayed on the display, or stored in a memory, for example.

In one aspect, the column driver and/or the scan logic may reside in a dedicated microelectronic device, such as, for example, an integrated circuit. For example, the device may include a Chip on Glass (COG), Chip on Flex (COF), or Tape Automated Bonding (T.A.B.) device. The microelectronic device may be included in a chipset, along with other components. Depending upon the particular intended device, components of the chipset may include one or more of a processor, BIOS, memory, memory controller, display controller, keyboard controller, timing controller, power controller, or scaler, to name just a few examples. In another aspect, the column driver and/or the scan logic may be incorporated into another microelectronic device, such as a graphics controller, display controller, for example. In still another aspect, the column driver and/or the scan logic may be incorporated into an active matrix TFT LCD substrate. The scan logic, or a portion of the scan driver, may also be included in a row driver, which may optionally be included in a microelectronic device or on the substrate with the column driver.

An example has been given for an LCD, although other embodiments of the invention are not limited to LCDs. In an alternate embodiment of the invention, an OLED display may be used. The OLEDs of the display may generate and emit colored light, such as, for example, red, blue, and green light. Native TFTs of the OLED display, or other photodetectors in each of the sub-pixels, may be used to detect light. The methods and apparatus disclosed for the LCSs may also optionally be adapted for the OLEDs.

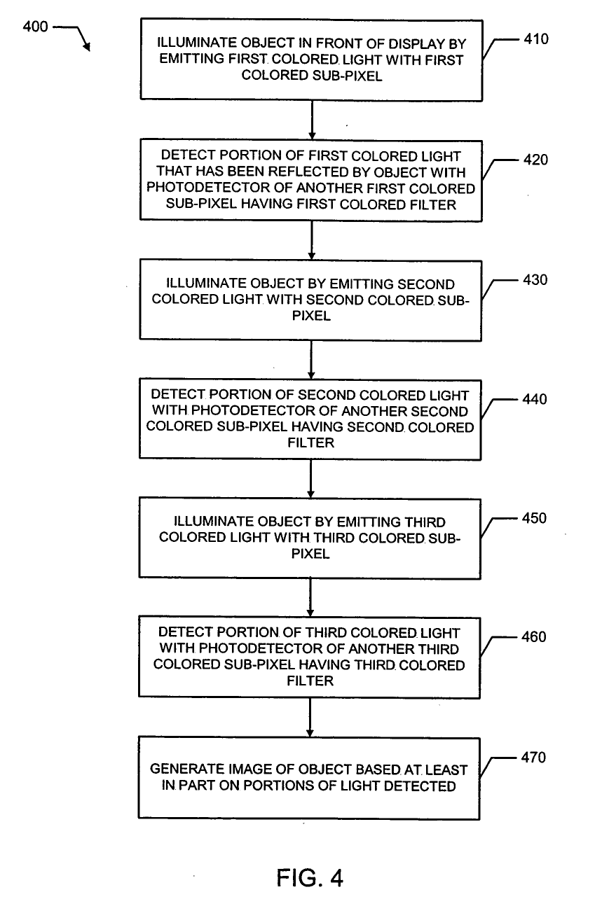

FIG. 4 shows a method 400 of generating an image of an object being scanned, according to one embodiment of the invention. The method includes sequentially emitting differently colored lights with sub-pixels of a display, sequentially detecting light with like colored sub-pixels that are not used to emit the light, and generating an image based on the sequentially detected lights.

The method includes illuminating an object in front of a display by emitting a first colored light with a first colored sub-pixel, at block 410. The object may include a photograph, business card, bar code, map, or fingerprint, to name just a few examples. By way of example, the first colored light may be a red light.

A portion of the first colored light that has been reflected by the object may be detected with a photodetector of another first colored sub-pixel having a first colored filter, at block 420. Some OLEDs and LCDs have colored filters. The first colored filter may tend to be transparent to the first colored light. Sub-pixels with differently colored filters may also be used to detect light, although these filters tend to be less transparent to the first colored light. The photodetector may include a native TFT of the display, which may also be used to allow the sub-pixel to emit light, or another type of photodetector, such as an PD, APD, or CCD, for example. In various aspects, the emitting first colored sub-pixel and the other detecting first colored sub-pixel may be in adjacent pixels of a row, adjacent pixels of a column, otherwise neighboring pixels, or otherwise proximate pixels (for example within five pixels of one another). By way of example, a detecting red sub-pixel may be in a pixel located adjacent to a pixel containing an emitting red sub-pixel.

Then, the object may be illuminated again by emitting a second colored light with a second colored sub-pixel, at block 430. By way of example, the second colored light may be a blue light.

A portion of the second colored light may be detected with a photodetector of another second colored sub-pixel having a second colored filter, at block 440. By way of example, a detecting blue sub-pixel may be in a pixel located adjacent to a pixel containing an emitting blue sub-pixel. The pixels may be, but need not be, the same as the pixels containing the previously described emitting and detecting first colored sub-pixels.

Then, the object may be illuminated again by emitting a third colored light with a third colored sub-pixel, at block 450. By way of example, the third colored light may be a green light.

A portion of the third colored light may be detected with a photodetector of another third colored sub-pixel having a third colored filter, at block 460. By way of example, a detecting green sub-pixel may be in a pixel located adjacent to a pixel containing an emitting green sub-pixel. The pixels may be, but need not be, the same as either the pixels containing the previously described emitting and detecting first colored sub-pixels, or the pixels containing the previously described emitting and detecting second colored sub-pixels.

Then, an image or other representation of the object may be generated based at least in part on the portions of the light detected, at block 470. Exemplary methods of generating the image will be described in greater detail below. Now, modifications and adaptations may be made to the method disclosed immediately above. Operations may be added to and/or omitted from the method. In an alternate embodiment of the invention, a subset of the method may be used. For example, a method may include a single emission and detection. This may be appropriate, for example, when scanning a black and white or other monochrome object, such as text, a business card, a black and white photograph, or the like. This may also be appropriate, for example, if a highly accurate color re-production is not required, for example if a red, blue, or green component of an image is sufficient. Alternatively, two sequential emissions and detections, instead of three, may be used.

Additionally, the method disclosed for individual pixels may be practiced with multiple pixels. For example, alternating red sub-pixels in a row may either emit or detect, then alternating blue sub-pixels of the row may either emit or detect, and then alternating green sub-pixels of the row may either emit or detect. Then the method may be repeated for other rows. The same sub-pixels and detectors need not be used in the sequential emissions and detections.

To give yet another example, in one embodiment of the invention, one or more sub-pixels of one or more rows of pixels above (row n−1) and/or below (row n+1) an intermediate row (row n) may be used to emit light, while one or more sub-pixels of the intermediate row (row n) may detect light. As discussed above, in one embodiment of the invention, the emitting sub-pixels may sequentially emit a plurality of colored lights, such as red light, blue light, and then green light, and the correspondingly colored detecting sub-pixels of the intermediate row may detect light through their colored filters. Many further variations are contemplated.

Not all displays include color filters. Some OLEDs include differently colored OLEDs that emit red, blue, and green colored lights, for example. Additionally, some color sequential displays include LEDs that sequentially generate differently colored backlights, such as red, blue, and green colored backlights, for example. Other color sequential displays have a color wheel that spins relative to a light source to sequentially generate differently colored lights, such as red, blue, and green colored lights, for example. Using color filters and sub-pixels is not required.

A method, according to one embodiment of the invention, may include illuminating an object in front of a display, such as an OLED or color sequential display, for example, by emitting a first colored light, such as red light, for example. In one aspect, a first colored LED, such as a red OLED of a sub-pixel, or a red LED used to provide backlight, for example, may be used to emit the first colored light. In another aspect, a spinning color wheel including, for example, a red filter, may be used to emit the first colored light. Then, a portion of the first colored light that has been reflected by the object may be detected with a first photodetector. It is not required that the detected light be passed through a color filter on its way to the photodetector. The total amount of the reflected light that is detected may provide information on the first color component or first color plane of the object.

In one aspect, the method may further include illuminating the object again by emitting a second colored light, such as blue light, for example. Then, a portion of the second colored light may be detected with a second photodetector. In a further aspect, the object may be illuminated again by emitting a third colored light, such as a green light, for example. Then, a portion of the third colored light may be detected with a third photodetector. Next, an image or other representation of the object may be generated based at least in part on the portions of the light detected.

Information on light detected from the color sequential emissions may be used to generate an image or other representation of the object being scanned. In one aspect, the information obtained from the sequential scans may include different sequentially determined color planes, such as red, blue, and green color planes, for example, of the object, as determined by scanning the object with different colored lights, such as red, blue, and green lights, for example. In one aspect, the data may be sparse, and interpolation may be used, for example, to determine a color component of a sub-pixel that was used to emit light. Then, after any interpolation, the image may be generated by combining, such as on the display, or on a printer, for example, the populated, less sparse, color planes.

In one embodiment of the invention, a scanner display apparatus, not necessarily a color scanner, as disclosed herein, may be used to provide a touch screen for an electronic device. A touch screen generally represents a screen on which a user may make a selection, for example by selecting text, graphics, an item from a menu, or another displayed option, to name a few examples, by touching the screen. While in scan mode, a plurality or region of sub-pixels of the display may display text, graphics, a menu, or other options that may be selected by a user. That is, while in scan mode, sub-pixels may emit, illuminate, or display information. Also, while in scanning mode, one or more other sub-pixels within, or at least proximate, the plurality or region of sub-pixels displaying the information, may detect light. By detecting light, the sub-pixels may be capable of detecting when a user makes a selection, for example by touching the screen with a finger, or pen, for example. At least some of the emitted light used to display the option may be reflected by the finger or pen, for example, and detected by the detecting sub-pixels in that region. As before, a native TFT or other photodetector may be used. Accordingly, in one embodiment of the invention, a native TFT of a display may be used as a photodetector to make a display a touch screen and receive a selection from a user.

The color scanner displays, drivers, TFT substrates, and other apparatus disclosed herein may be included and used in a wide variety of electronic devices. Suitable electronic devices include, but are not limited to, televisions, desktop computers, laptop computers, PDAs, cellular phones, and e-books, to name just a few examples.

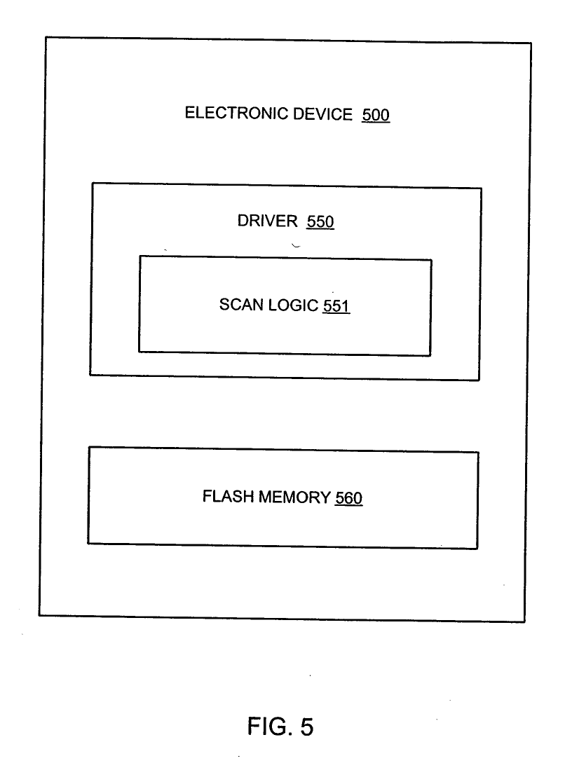

FIG. 5 shows an exemplary electronic device 500, according to one embodiment of the invention. The electronic device includes a driver 550 to control sub-pixels of a color display of the device. The driver may have any one or more of the characteristics of the drivers disclosed herein.

The driver includes scan logic 551. In one embodiment of the invention, the scan logic may include logic to cause a first sub-pixel of the color display to emit light and a second potentially differently colored sub-pixel of the color display to detect light.

The electronic device also includes a Flash memory 560. The electronic device may use the Flash memory to store information, such as, for example, information associated with a scan. As one example, the electronic device may store information about how much light was detected by one or more sub-pixels in the Flash memory. As another example, the electronic device may store an image of an object that has been scanned in the Flash memory. Flash memories are used in some, but not all, electronic devices.

In an alternate embodiment of the invention, a driver may be included in an electronic device, such as a desktop or laptop computer, for example, which may also include one or more of a graphics controller and/or a network interface. The graphics controller may be used to process graphical data, such as data of a scanned image, for example. The network interface may be used to transmit a scanned image over a network, for example. Graphics controllers and network interfaces are used in some, but not all, electronic devices.

In another embodiment of the invention, a driver may be included in a wireless electronic device, such as, for example, a cellular phone, which may also include an omnidirectional or dipole antenna, for example. The antenna may be used to transmit and receive data, such as an image of a scanned object, for example. Omnidirectional and dipole antennas are used in some, but not all, wireless devices.

In the description above, for the purposes of explanation, numerous specific details have been set forth in order to provide a thorough understanding of the embodiments of the invention. It will be apparent, however, to one skilled in the art, that other embodiments may be practiced without some of these specific details. In other instances, well-known circuits, structures, devices, and techniques have been shown in block diagram form or without detail in order not to obscure the understanding of this description.

Additionally, while the invention has been described above in terms of several embodiments, those skilled in the art will recognize that the invention is not limited to the embodiments described, but may be practiced with modification and alteration within the spirit and scope of the appended claims.

For example, embodiments of the invention have been described in terms of display screens including red, blue, and green sub-pixels, as these are currently in widespread use. However, the invention is not so limited. A suitable display, according to one embodiment of the invention, may include cyan, magenta, and yellow sub-pixels. Also, the invention is not limited to displays including red, blue, and green sub-pixels. A suitable display, according to another embodiment of the invention, may include another colored sub-pixel. For example, some displays include a white sub-pixel in each pixel, in addition to the red, blue, and green sub-pixels. The white pixel may be used to emit white light in a scan. This may be appropriate, for example, to provide white light or more light. In another embodiment, one or more sub-pixels may be shared between pixels. Many further variations are contemplated. The description above is thus to be regarded as illustrative instead of limiting.

Many of the methods are described in their most basic form, but operations may be added to or deleted from the methods. It will be apparent to those skilled in the art that many further modifications and adaptations may be made. The particular embodiments are not provided to limit the invention but to illustrate it. The scope of the invention is not to be determined by the specific examples provided above but by the claims below.

An embodiment of the invention may include various operations. The operations of the embodiment may be performed by hardware components, or may be embodied in machine-executable instructions, which may be used to cause or result in a general-purpose or special-purpose processor or logic circuits programmed with the instructions to perform the operations. Alternatively, the operations may be performed by a combination of hardware and software.

An embodiment of the invention may be provided as a program product or other article of manufacture that may include a machine-accessible or readable medium having stored thereon one or more instructions and/or data structures. The machine-accessible medium may provide the instructions, which, if executed by a machine, may cause or result in the machine to perform one or more operations or methods as disclosed herein. For example, in one embodiment of the invention, software to generate an image based on and using detected light may be stored on the machine-accessible or readable medium.

Suitable machines include, but are not limited to, computers, network devices, PDAs, manufacturing tools, cellular phones, and a wide variety of other devices with one or more processors, to name just a few examples. The machine-accessible medium may include, any mechanism that provides, for example stores and/or transmits, information in a form that is accessible by a machine. For example, a machine-accessible medium may include recordable and/or non-recordable media, such as a floppy diskette, optical storage media, optical disk, CD-ROM, magnetic disk storage media, magneto-optical disk, read only memory (ROM), random access memory (RAM), EPROM, EEPROM, Flash memory, or combination, to name just a few examples.

A machine-accessible medium may also include an electrical, optical, acoustical or other form of propagated signal, such as carrier waves, infrared signals, digital signals, for example. An embodiment of the invention may be downloaded as a computer program product, wherein the program may be transferred from one computer or other machine to another computer or other machine by way of data signals embodied in a carrier wave or other propagation signal or medium via a communication link (for example a modem or network connection).

In the claims, any element that does not explicitly state “means for” performing a specified function, or “step for” performing a specified function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

What is claimed is:

1. A method comprising:
illuminating an object in front of a display by emitting light with the display; and
detecting light with a plurality of thin film transistors of the display.

2. The method of claim 1, wherein said emitting the light comprises emitting an additive primary light selected from red light, blue light, and green light.

3. The method of claim 1, further comprising changing a bias of the thin film transistors to increase sensitivity to the light.

4. The method of claim 1, further comprising using the detected light to generate an image of the object.

5. The method of claim 1, wherein said illuminating comprises displaying a touch screen option on the display, and wherein said detecting comprises detecting a selection of the touch screen option.

6. A method comprising:
illuminating an object in front of a display by emitting a first colored light;
detecting a portion of the first colored light that has been reflected by the object with a first photodetector;
illuminating the object by emitting a second colored light; and
detecting a portion of the second colored light with a second photodetector.

7. The method of claim 6, further comprising:
illuminating the object by emitting a third colored light;
detecting a portion of the third colored light with a third photodetector; and
generating an image of the object based at least in part on the portions of the light detected.

8. The method of claim 7, wherein said emitting the first colored light, the second colored light, and the third colored light each comprise emitting a different additive primary colored light selected from red light, blue light, and green light.

9. The method of claim 6, wherein said detecting the portion of the first colored light comprises detecting with one or more selected from a thin film transistor and a diode, wherein the thin film transistor and the diode are each connected to be used to allow a sub-pixel in which they are included to emit light.

10. The method of claim 6, wherein said illuminating comprises displaying a touch screen option on the display, and wherein said detecting comprises detecting a selection of the touch screen option.

11. A method comprising:
illuminating an object in front of a display by emitting a first colored light with a first colored sub-pixel; and
detecting a portion of the first colored light that has been reflected by the object with a photodetector of another first colored sub-pixel having a first colored filter. illuminating the object by emitting a second colored light with a second colored sub-pixel; and
detecting a portion of the second colored light with a photodetector of another second colored sub-pixel having a second colored filter.
illuminating the object by emitting a third colored light with a third colored sub-pixel;
detecting a portion of the third colored light with a photodetector of another third colored sub-pixel having a third colored filter; and
generating an image of the object based at least in part on the portions of the light detected.

12. A method comprising:
illuminating an object in front of a display by emitting a light with the display;
detecting a first portion of the light with a first photodetector of a first colored sub-pixel having a first colored filter;
detecting a second portion of the light with a second photodetector of a second colored sub-pixel having a second colored filter; and
detecting a third portion of the light with a third photodetector of a third colored sub-pixel having a third colored filter.

13. The method of claim 12, wherein said emitting comprises emitting white light.

14. The method of claim 12, wherein said emitting comprises emitting with red, blue, and green sub-pixels of a first pixel, and wherein said detecting with the first, the second, and the third photodetectors comprises detecting with photodetectors in red, blue, and green sub-pixels of a second pixel that is adjacent to the first pixel.

15. The method of claim 12, wherein said detecting the portion of the first colored light comprises detecting with one or more selected from a thin film transistor and a diode, wherein the thin film transistor and the diode are each connected to be used to allow a sub-pixel in which they are included to emit light.

16. The method of claim 12, further comprising generating an image of the object based at least in part on the portions of the light detected.

17. The method of claim 12, wherein said illuminating comprises displaying a touch screen option on the display, and wherein said detecting comprises detecting a selection of the touch screen option.

18. An apparatus comprising:
a driver to control sub-pixels of a color display;
logic of the driver to cause a first sub-pixel of the color display to emit light and a second sub-pixel of the color display to detect light.

19. The apparatus of claim 18, further comprising logic of the driver to receive an electrical signal from the second sub-pixel.

20. The apparatus of claim 19, further comprising logic of the driver to extract information from the received electrical signal.

21. The apparatus of claim 18, wherein the first sub-pixel and the second sub-pixel are same colored sub-pixels in adjacent pixels.

22. A system comprising:
a color display;
a first sub-pixel of the color display;
a second sub-pixel of the color display;
a driver to control the first and the second sub-pixels of the color display;
logic of the driver to cause the first sub-pixel to emit light and the second sub-pixel to detect light; and
a Flash memory to store information associated with the light detected by the second sub-pixel.

23. The system of claim 22, further comprising logic of the driver to receive an electrical signal from the second sub-pixel.

24. The system of claim 23, further comprising logic of the driver to extract information from the received electrical signal.

25. The system of claim 24, further comprising:
a processor; and
an electrical connection between the driver and the processor to allow the driver to provide the extracted information to the processor.

26. An article of manufacture comprising:
a machine-accessible medium that provides instructions that if executed result in a machine performing operations including,
receiving a plurality of different color planes associated with an object scanned with different colored lights; and
generating an image of the object scanned by combining the plurality of color planes.

27. The article of manufacture of claim 26, wherein the machine-accessible medium further provides instructions that if executed result in the machine performing operations including,
interpolating data of a color plane to determine a color component of a sub-pixel used to emit light instead of detect light in a scan.

28. The article of manufacture of claim 26, wherein the machine-accessible medium further provides instructions that if executed result in the machine performing operations including,
combining a red color plane, a blue color plane, and a green color plane.
